(19) United States
(12) Patent Application Publication
(10) Pub. No.: US 2009/0052891 A1
(43) Pub. Date: Feb. 26, 2009

(54) Method and Apparatus for Reducing Error Rate During Data Transmission in an Optical Communications Network

(75) Inventors: David A. DeLew, Rohnert Park, CA (US); Vinita Gupta, San Rafael, CA (US); Edward J. Sackman, Santa Rosa, CA (US); Robert S. Larvenz, Rohnert Park, CA (US)

Correspondence Address: James M. Wu;JW Law Group, 84 W. Santa Clara Street, Suite 820, San Jose, CA, 95113, US

(73) Assignee: Tellabs Petaluma, Inc., Naperville, IL (US)

(21) Appl. No.: 11/843,644

(22) Filed: Aug. 22, 2007

(51) Int. Cl. H04B 17/00

(52) U.S. Cl. 398/26

(57) ABSTRACT

An apparatus and a method of enhancing data integrity for data transmission over an optical network are disclosed. Upon detecting a low performance condition associated to the optical communications network, an error correcting code (“ECC”) device is activated. The ECC device inserts the ECC to a data stream to form an ECC data stream. Once the ECC data stream reaches to the destination, the ECC device corrects any errors incurred during the transmission, and removes the ECC from the ECC data stream. It should be noted that the ECC device can also be activated by a request from a network operator.

### FIELD

The exemplary embodiment(s) of the present invention relates to optical communications networks. More specifically, the exemplary embodiment(s) of the present invention relates to enhancing signal to noise ratio during data transmission in an optical communications network.

### BACKGROUND

With increasing demand of more information to be supplied to homes and/or businesses, many network communication providers are switching or upgrading their networks to optical communications networks. In order to supply more information in the form of video, audio and telephony at higher rates, higher bandwidth communication networks are required. Optical communications networks can typically support high speed audio, video, and data transmission to/from homes and/or businesses. Typical example of optical network architecture may be fiber to the x (“FTTX”), which includes fiber to the node/neighborhood (“FTTN”), fiber to the curb (“FTTC”), fiber to the building (“FTTB”), fiber to the home (“FTTH”) or other edge location to which a fiber network extends.

To transmit an optical signal from a source to a destination over an optical communications network, the signal typically travels through multiple optical components, such as an optical network terminal (“ONT”), an optical distribution network (“ODN”), an passive optical network (“PON”), an optical line termination (“OLT”), and the like. Each of the optical components may occasionally malfunction in such a way that the upstream or downstream signal has too low a signal-to-noise ratio (“SNR”). A malfunctioning optical component, for example, causes a rogue ONT due to weak signals and high noise level, which typically causes misinterpretation of data as well as commands. Rogue ONT is constantly or repeatedly re-ranging, which disrupts ONT/OLT communications.

For the upstream signals, a low SNR can be caused by various reasons, such as, for example, a low jitter tolerance setting in OLT, a high jitter output from the ONT, a weak ONT's laser, defective ODN(s), kinked fiber(s), long fiber(s), dirty fiber terminations, or so forth. Similarly, for the downstream signals, a low SNR may be caused by similar reasons as the upstream signals, such as, for example, a low jitter tolerance setting on the ONT, a high jitter output from the OLT, a weak OLT's laser, a defective ODN, kinked fiber(s), long fiber(s), dirty fiber terminations, et cetera. In a PON system, ONTs transmit data to an OLT using a common optical wavelength and fiber optic media. A malfunctioning OLT may, for example, send signals to an ONT with too low a SNR resulting in a high bit error rate, which typically causes the OLT not being able to communicate with some or all of the ONTs. An ONT is typically forced to re-range when it detects an error sequence that exceeds, for example, the G.983.1 BIP-8 thresholds. A rogue ONT or repeatedly re-ranging ONT will cause a network to fail.

A conventional approach for identifying the failure of a network is to individually disconnect ONTs from an ODN and look for the source of the failure. Alternatively, another approach is to disconnect the ODN from the OLT and connect test equipment to the ODN to identify the source of the failure.

### SUMMARY

A method and apparatus for reducing the error rate and enhancing the data integrity for data transmission over an optical communications network are described. Upon detecting a high error rate relating to the network, an error correcting code (“ECC”) device is activated to reduce the error rate. The ECC device, in one embodiment, encodes the ECC into a data stream to create an ECC data stream before it is being transmitted. Once the ECC data stream reaches to the destination, the ECC device corrects any errors incurred during the transmission, and removes the ECC from the ECC data stream. It should be noted that the ECC device can also be activated by a request from a network operator.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIGS. 1A-B illustrate an optical communications network using an ECC mechanism in accordance with one embodiment of the present invention;

FIG. 2 is a block diagram illustrating an optical communication network using ECC encoder and ECC decoder in accordance with one embodiment of the present invention;

FIG. 3 is a flowchart illustrating a process of using ECC to enhance data integrity in accordance with one embodiment of the present invention; and

FIG. 4 is a flowchart illustrating an alternative example of an error correcting process to enhance data integrity in accordance with one embodiment of the present invention.

### DETAILED DESCRIPTION

Exemplary embodiment(s) of the present invention is described herein in the context of a method, system and apparatus of enhancing data integrity for data transmission over an optical communications network. Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skilled in the art having the benefit of this disclosure.

A mechanism for reducing the error rate and enhancing the data integrity for data transmission over an optical communications network are described. Upon detecting a high error rate relating to the network, an error correcting code (“ECC”) device is activated to reduce the error rate. The ECC device, in one embodiment, encodes the ECC into a data stream to create an ECC data stream before it is being transmitted. Once the ECC data stream reaches to the destination, the ECC device corrects any errors incurred during the transmission, and removes the ECC from the ECC data stream. It should be noted that the ECC device can also be activated by a request from a network operator.

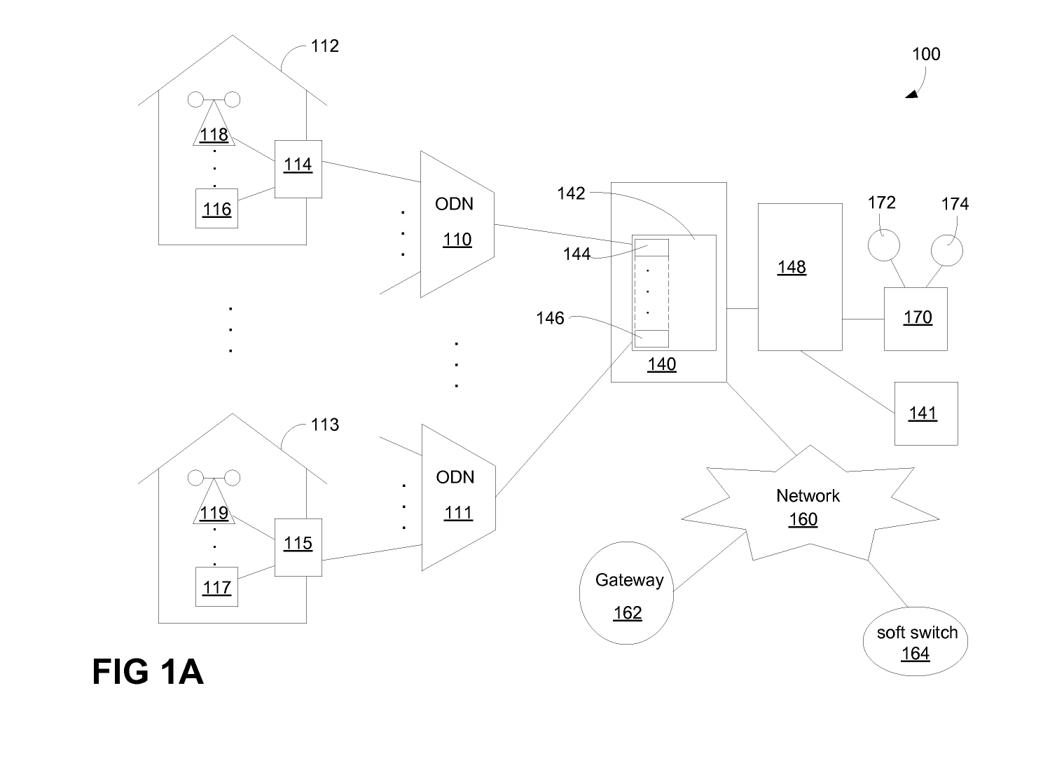

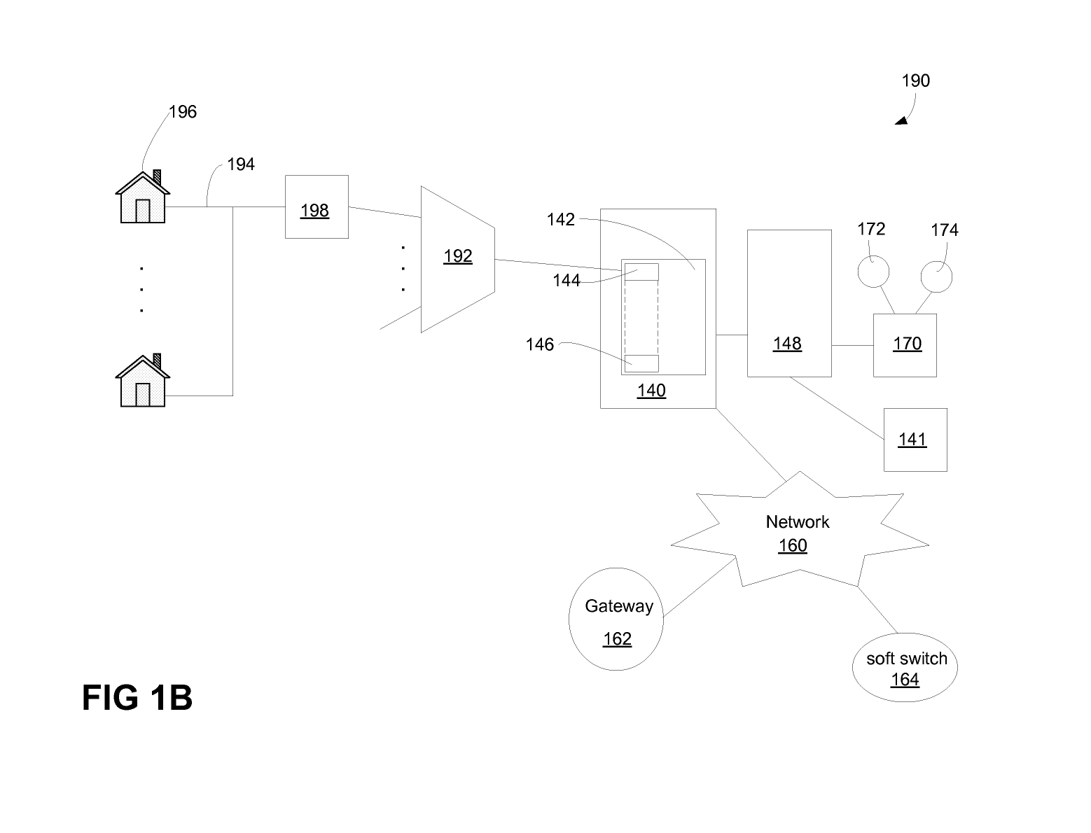

FIG. 1A illustrate an optical communications network 100 using an ECC mechanism in accordance with one embodiment of the present invention. Network 100 is a fiber to the premises (“FTTP”) optical network architecture, which distributes optical signals from a central office 140 to one or more optical network terminals or optical network terminations (“ONTs”) wherein the ONTs generally reside at customers' or users' premises 112-113. Network 100 further includes NMS 148, central offices 140-141, a network connection 160, optical distribution networks (“ODNs”) 110-111, and ONTs 114-115. Network connection 160 may be used to connect to a video network or wireless network and it may further optionally coupled to a gateway device 162 and a soft switch 164.

Central office 140, for example, further includes an optical line termination (“OLT”) 142. Each OLT 142 is capable of supporting a group of passive optical networks (“PONs”) 144-146 wherein each one of PONs 144-146 is further capable of coupling one or more ODNs. Each ODN provides optical data transmission between a PON and a group of ONTs. For example, the group of ONTs may include anywhere from 1 to 64 ONTs. Alternatively, a PON may support more than 64 ONTs depending on the layout of the optical network. NMS 148 is coupled to central offices 140-141, and a server 170. Server 170 is coupled to users 172-174 wherein users 172-174 can be network operators and/or other servers (or processing devices). A function of NMS 148 is to display network information to the NMS client such as users 172 or 174 via server 170.

ONT 114, as shown in FIG. 1A, is physically situated at customer's premise 112, wherein premise 112 further includes various local communication devices (or equipments) such as voice device 118 and device 116. While voice device 118 may be a wired or wireless voice device, device 116 may be a personal computer, a set-top-box (“STB”), or a modem. A function of ONT is to convert signal format between optical signals and electrical signals. For instance, ONT 114 receives optical signals from a corresponding ODN 110 and subsequently converts the optical signals to electrical signals before the electrical signals are being transmitted to devices 116 and 118. Similarly, ONT 114 receives electrical signals from local devices 116 and/or 118, and then converts the electrical signals to optical signals before being transmitted to ODN 110. In one embodiment, ONT 114 includes an ECC device, which further includes an ECC encoder and an ECC decoder. The ECC device enables ONT 114 to correct data error(s) occurred during the transmission. It should be noted that ONT 115 is coupled to local devices 117-119 at customer's premise 113 and performs similar functions as mounting system 114.

OLT 142 is located at central office 140 and is coupled to multiple PONs 144-146. OLT 142, in one aspect, can be considered as the endpoints for PONs 144-146. For example, OLT 142, in one configuration, is capable of managing up to 52 PONs. Alternatively, OLT can control more than 52 PONs depending on the structure of the optical communications network. Multiple PONs 144-146 are coupled to multiple ODNs 110-111, as illustrated in FIG. 1A, wherein a function of an ODN is to split a single optical fiber into multiple optical fibers. For example, PON 144 feeds a single optical fiber to ODN 110 and ODN 110 subsequently splits the single optical fiber from PON 144 to multiple optical fibers feeding to multiple ONTs including ONT(s) at mounting system 114 or 115. In one embodiment, OLT 142 is configured to include an ECC device, which enables OLT 142 to detect and correct error(s) before passing the received data to other optical and/or electrical devices.

Referring back to FIG. 1A, NMS 148 is used to maintain and monitor a communications network. For example, NMS 148 provides functions for controlling, planning, allocating, deploying, coordinating, and monitoring the resources of a network, including performing functions, such as fault management, configuration management, accounting management, performance management, and security management (“FCAPS”). The fault management is configured to identify, correct and store faults that occur in an optical network. While the configuration management identifies, simplifies, and tracks the network configuration, the accounting management identifies and collects usage statistics for the customers or users. Also, the performance management determines the efficiency of the current network, such as throughput, percentage utilization, error rates and response time. It should be noted that performance thresholds can trigger alarms and alerts. Security management maintains a process of controlling access to the network.

In operation, upon detecting a low SNR, a standard G.983.1 Physical Layer Operation Administration and Maintenance (“PLOAM”) message format is encapsulated in a new data format that includes the ECC thereby error(s) incurred during the transmission may be removed using the ECC and the original G.983.1 message may be restored at the destination. It should be noted that a network operator can manually provision the ECC device relating to activating and deactivating. Alternatively, a network controller can automatically activate the ECC device when an error rate exceeds a predefined threshold. It should be further noted that the ECC device can be deactivated when a low error rate is achieved.

FIG. 1B is an optical communications network 190 illustrating a FTTN network architecture having an error correcting system in accordance with one embodiment of the present invention. FTTN, which is also known as fiber to the node, fiber to the neighborhood, or fiber to the cabinet, is an optical communication network using fiber optic cables reach to a cabinet for providing network services to a neighborhood. Users can connect to the cabinet using coaxial cable(s) or twisted pair cable(s). The neighborhood served by the FTTC is usually around 5,000 feet or less between the cabinet and users.

Network 190 includes an optical network unit (“ONU”) 198, cables 194, and local network connector 196. ONU 198 is capable of communicating with PON 144 using optical signals while it is also capable of communicating with local network connector 196 using electrical signals. Cable 194 may be a coaxial cable or twisted pair wherein the range of cable 194 is usually less than 5,000 feet. In one embodiment, ONU 198 is configured to include an ECC device, which enables ONU 198 to detect and correct any error(s) before it passes the data onto the next managed entity such as splitter 192.

It should be noted that the exemplary embodiment(s) of the ECC system can be employed in any FTTX network architectures for enhancing the network performance. An advantage of using the error correcting mechanism is to enhance the data integrity, which reduces the network down time. For example, the error correcting mechanism or the ECC device is capable of correcting error bits caused by the low SNR, and also suspending communications between a rogue ONT and an OLT on a Time Division Multiple Access (“TDMA”) Optical Distribution Network. It should be noted that the error correcting mechanism is also referred to as a low SNR error correction algorithm.

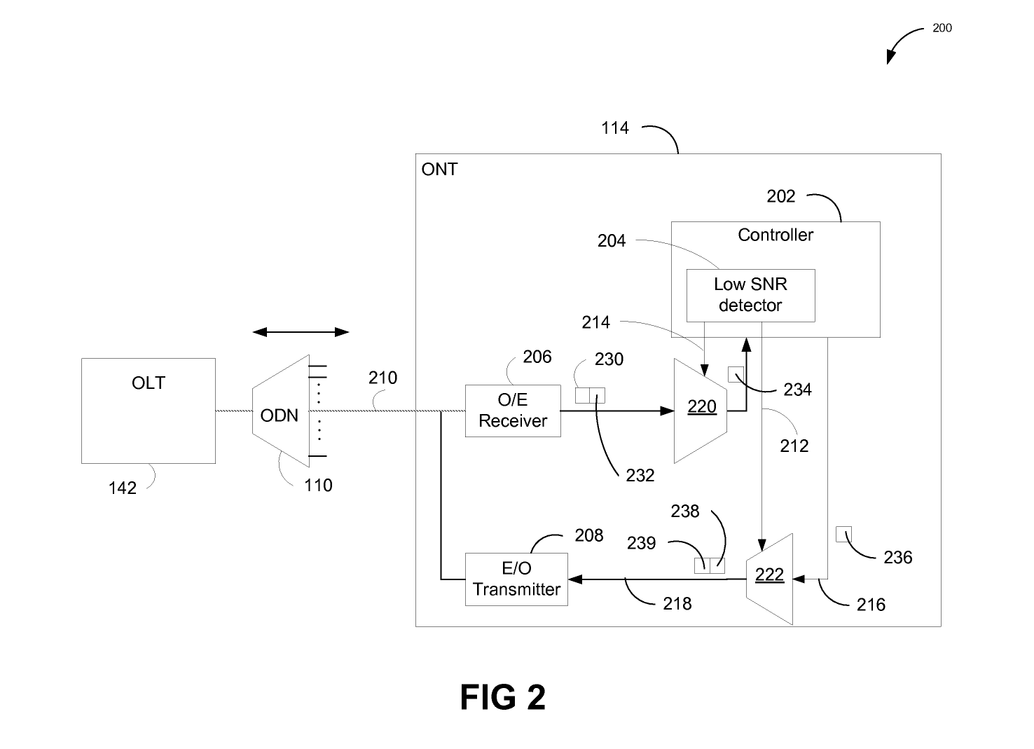

FIG. 2 is a block diagram illustrating an optical communication network 200 using an ECC device in accordance with one embodiment of the present invention. Network 200 illustrates an OLT 142, an ODN 110, and an ONT 114 wherein ONT 114 further includes an ECC device. ECC device, in one embodiment, includes an ECC encoder 222 and an ECC decoder 220. ONT 114 further includes a controller 202, optical to electrical (“O/E”) receiver 206, and electrical to optical (“E/O”) transmitter 208. Controller 202 further includes a low SNR detector 204. It should be noted that low SNR detector 204 may be an independent device. Alternatively, low SNR detector 204 is a part of controller 202. It should be noted that the underlying concept of the embodiment does not change if one or more functional elements were added to or removed from network 200.

Controller 202, in one embodiment, is a processing unit that controls data flow for ONT 114. Controller 202 may be a microprocessor, a central processing unit, or any devices capable of executing instructions. Low SNR detector 204, in one embodiment, is a part of controller 202 and is capable of detecting low performance associated with the optical communications network, such as high noise level and low SNR. Detector 204, as shown in FIG. 2, controls ECC encoder 222 and ECC decoder 220.

ECC decoder 220, in one embodiment, is capable of receiving an ECC data stream from ODN 110. A portion of the ECC data stream is ECC bits 230 while another portion of the ECC data stream is data 232. ECC decoder 220 corrects any error bit(s) in the ECC data stream, and subsequently, restores the ECC data stream to its original data format 234 by removing ECC bits 230. It should be noted that the network operator(s) or system controller determines how many error bits that the ECC device is capable of correcting. More ECC bits are required to be encoded in the data stream if more error bits are needed for correction. Upon correcting the error bit(s) and restoring the data stream, data stream 234, which may include multiple data packets, is passed from decoder 220 to controller 202. In one embodiment, ECC decoder 220 is a part of O/E receiver 206. Alternatively, ECC decoder 220 is an independent hardware optical element that places between O/E receiver 206 and ODN 110.

ECC encoder 222, in one embodiment, is capable of receiving a data stream 236 from controller 202 and encodes ECC bits into the data stream 236 to form an ECC data stream which includes ECC bits 238 and data 239. Once the ECC data stream 238-239 is composed, it is transmitted from E/O transmitter 208 to ODN 110. ECC encoder 222, in one embodiment, is an optical hardware device that is situated between E/O transmitter 208 and ODN 110. Alternatively, ECC encoder 222 is a part of E/O transmitter 208. It should be noted that the ECC device can also be resided in controller 202. It should be further noted that OLT 142 should employ similar ECC functions as ONT 114 does.

Low SNR detector 204, in one embodiment, is capable of deactivating the ECC device, so that data stream(s) can pass through ECC encoder 222 and decoder 220 without performing any ECC functions. Low SNR detector 204 may be controlled by a network operator thereby the network operator controls ECC encoder 222 and ECC decoder 220 via low SNR detector 204. Law SNR detector 204 is also capable of activating the ECC device when a high error rate or low SNR is detected. For example, when a standard ITU G.983.1 error detection method detects an error condition that causes repetitive re-ranging of an ONT, low SNR detector 204 turns off the standard message format, which uses 8-bit cyclic redundancy check (“CRC”), and turns on ECC in the message format to reduce the error rate. If the message format utilizing the ECC still can not reach an error rate level that is low enough for an ONT to operate normally, the OLT and/or other optical interface devices may set the rogue ONT to an ESTOP state, which temporary decommission or suspend the rogue ONT.

An advantage of using the ECC mechanism over an optical communications network is to remove rogue ONT(s) from the network for keeping the network from failing.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components. While embodiments of the present invention will be described with reference to the Internet, the method and apparatus described herein is equally applicable to other network infrastructures or other data communications environments.

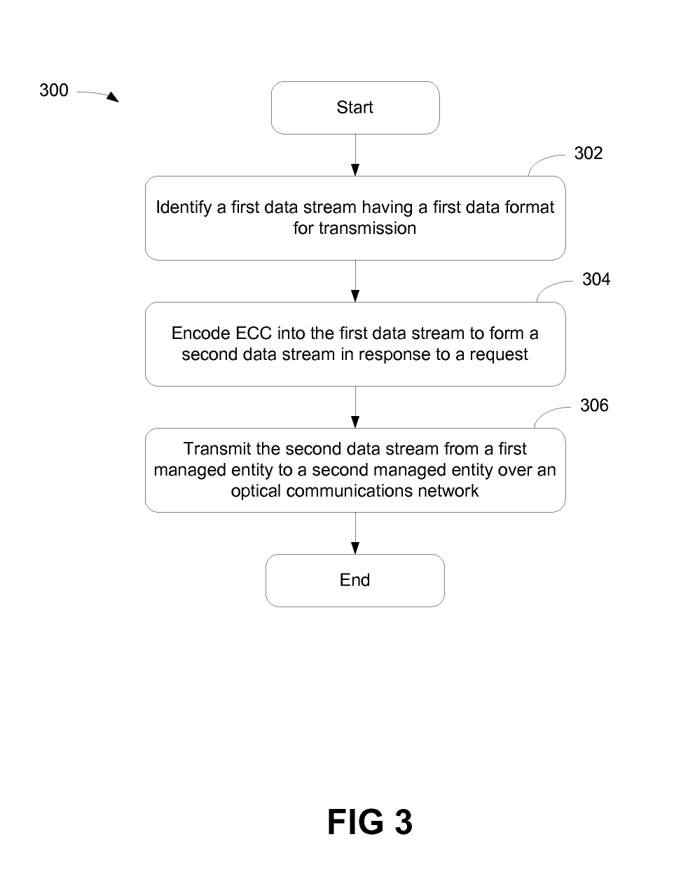

FIG. 3 is a flowchart 300 illustrating a process of using ECC to enhance data integrity in accordance with one embodiment of the present invention. At block 302, a process identifies a first data stream having a first data format, which is ready to transmit over an optical communications network. If the process detects a low performance of a managed entity over the optical communications network, it activates the ECC device to enhance the network performance. For example, the process obtains current SNR and compares the current SNR against a predefined SNR to identify whether a low SNR condition exists. A low SNR may cause an ONT to continuously re-range partially because of weak signals together with high noise level. In another embodiment, the process is capable of detecting a re-ranging number of a rogue ONT in which the re-ranging number exceeds a normal re-ranging number. It should be noted that the process is capable of recognizing the data format in International Telecommunication Union (“ITU”) G.983.x as the first data format. After block 302, the process moves to the next block.

At block 304, the process encodes ECC into the first data stream to form a second data stream in response to a request. The request, in one embodiment, is issued by a network operator or a low SNR detector or a combination of both. For example, upon receiving the request, the first data stream with ITU G.983.x data format is encapsulated in the second data stream, which includes Turbo Code™ for enhancing data integrity. After block 304, the process moves to the next block.

At block 306, the process transmits the second data stream from a first managed entity to a second managed entity over an optical communications network. In one example, the first managed entity is an ONT and the second managed entity is an OLT. Upon receiving the second data stream, the process corrects error bit(s) occurred during the transmission using the ECC. After correction, the ECC bits are subsequently removed and the original first data stream is restored. The ECC device can be deactivated when the low performance condition ceases to exist. Alternatively, the data transmission is suspended when the low performance condition persists after the ECC device is activated. After block 306, the process ends.

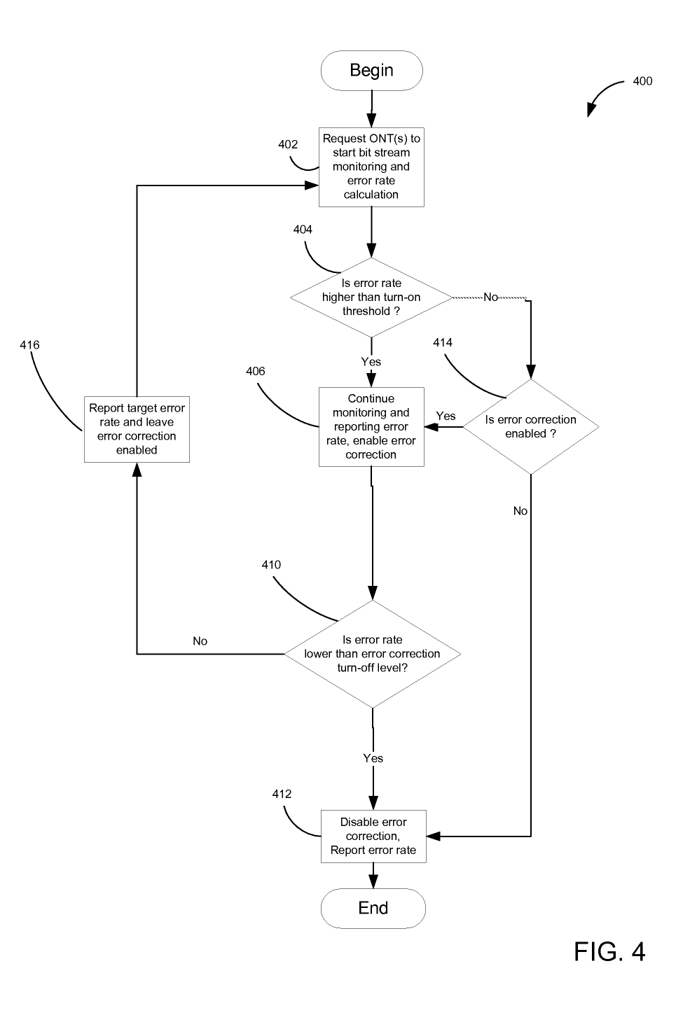

FIG. 4 is a flowchart 400 illustrating an alternative example of an error correcting process for enhancing data integrity in accordance with one embodiment of the present invention. At block 402, upon requesting an ONT to start a bit stream, which, in one embodiment, includes multiple data packets, the process monitors and calculates an updated error rate in response to a current error rate. Current error rate includes various types of errors such as a low SNR condition. A maximum error rate before system failure or threshold may be set by a network operator. Various error conditions can exceed a user defined threshold of ONT re-ranges due to many conditions such as exceeding the G.983.1 bit-interleaved parity with eight-bit error (“BIP-8”), or semi-delay-insensitive (“SDi”), or loss of cell delineation (“LOCD”), or full-response maximum likelihood (“FRML”) error thresholds. It should be noted that an operation of system maintenance can detect a low SNR condition. Also, a network operator can set a low SNR. After block 402, the process moves to the next block.

At block 404, upon retrieving a predefined threshold error rate (“threshold”), which is the up-limit (or maximum) of an error rate that a network can tolerate before it fails (or goes down), the process compares the updated (or calculated) error rate against the threshold. If the updated error rate is greater than the threshold, the process proceeds to block 406, otherwise, the process moves to block 412.

At block 406, the process activates the ECC device to enhance data integrity across the network. After reporting the error rate, the process continues to monitor the network performance, and calculates/updates the error rate. To correct errors in response to the low SNR, the process changes the standard G.983.1 message format at the OLT (and/or the ONT) by adding various ECC bits or parameters to the message being sent. The messages having the ECC are transmitted both in the upstream path from the ONT to OLT and in the downstream path from the OLT to the ONT. In one embodiment, the ECC is Turbo Code™, or a version of the ‘Reed-Solomon’ ECC™. After block 406, the process proceeds to block 410.

At block 410, the process compares the updated error rate with a predefined error correction (“EC”) turn-off level. EC turn-off level, in one embodiment, is an error rate that is sufficiently low that error correcting is no longer necessary to maintain the network operating. In one example, a predefined EC turn-off level may be provisioned or set by a network operator. Alternatively, the EC turn-off level may be automatically set in response to network status. The process moves to block 412 if the updated error rate is less than EC turn-off level. Otherwise, the process moves to block 416.

At block 416, while the process continues to monitor the error rate, it continues to enable the ECC device. Upon reporting the target error rate, the process proceeds to block 402. It should be noted that the target error rate, in one embodiment, is the EC turn-off level. It should be further noted that the target error rate may be set by a network operator. It should be further noted that after completing the change to the new protocol using ECCs, a notification is sent to a network operator. If, on the other hand, the error correcting mechanism fails to restore stable communications, which means to keep the current error rate less than the threshold, the process, in one embodiment, provisions the rogue OLT and/or ONT to the ESTOP state.

At block 414, the process proceeds to block 406 if the ECC device is enabled. Otherwise, the process moves to block 412.

At block 412, upon reporting the current error rate, the process disables the ECC device. Once the ECC device is disabled, the data streams continue to be transmitted over the optical communications network without using the error correcting capability. After block 412, the process ends.

While particular embodiments of the present invention have been shown and described, it will be obvious to those skilled in the art that, based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A method for data transmission comprising:
identifying a first data stream having a first data format for transmission;
encoding error correcting code (“ECC”) to the first data stream to form a second data stream in response to a request; and
transmitting the second data stream from a first managed entity to a second managed entity over an optical communications network.

2. The method of claim 1, further comprising:
detecting a low performance condition associated to the optical communications network; and
activating an ECC device in response to the low performance condition.

3. The method of claim 2, wherein detecting a low performance condition further includes comparing a detected signal-to-noise ratio (“SNR”) against a predefined SNR.

4. The method of claim 2, wherein detecting a low performance condition further includes detecting exceeding numbers of re-ranging of an optical network terminal (“ONT”).

5. The method of claim 1, further comprising:
receiving the second data stream;
correcting an error in the second data stream in response to the ECC; and
removing the ECC from the second data stream to restore the first data stream with the first data format.

6. The method of claim 5, further comprising deactivating the ECC device when the low performance condition is ceased to exist.

7. The method of claim 5, further comprising
monitoring the low performance condition; and
suspending data transmission between the second managed entity and the first managed entity when the low performance condition continues.

8. The method of claim 1, wherein the identifying a first data stream having a first data format for transmission further includes:
identifying a plurality of data packets within the first data stream; and
recognizing standard data format in accordance with International Telecommunication Union (“ITU”) G.983.x in the first data format.

9. The method of claim 8, wherein the encoding ECC into the first data stream to form a second data stream further includes encapsulating the first data stream with the ITU G.983.x data format with Turbo Code™ to enhance data integrity.

10. The method of claim 8, wherein the encoding error correcting code (“ECC”) into the first data stream to form a second data stream in response to a request further includes receiving the request from a network operator.

11. A method for reducing error rate comprising:
detecting a low signal-to-noise ratio (“SNR”) between an optical network terminal (“ONT”) and an optical line termination (“OLT”);
inserting error correcting code (“ECC”) into a first data packet having a standard data format to form a second data packet including the first data packet and the ECC;
transmitting the second data packet from the OLT to the ONT over an optical communications network; and
restoring the first data packet with the standard data format from the second data packet after the second data packet is received by the ONT.

12. The method of claim 11, wherein the detecting a low SNR further includes comparing a detected SNR against a predefined SNR.

13. The method of claim 11, wherein the restoring the first data packet with the standard data format from the second data packet further includes:
correcting at least one error in the second data packet in response to the ECC; and
removing the ECC from the second data packet to restore the first data packet with original data format.

14. The method of claim 11, further comprising deactivating an ECC encoder when the low SNR is ceased to exist.

15. The method of claim 11, further comprising suspending data transmission between the ONT and the OLT when the low SNR continues to exist.

16. An apparatus for data transmission comprising:
means for identifying a first data stream having a first data format for transmission;
means for encoding error correcting code (“ECC”) to the first data stream to form a second data stream in response to a request; and
means for transmitting the second data stream from a first managed entity to a second managed entity over an optical communications network.

17. The apparatus of claim 16, further comprising:
means for detecting a low performance condition associated to the optical communications network; and
means for activating an ECC device in response to the low performance condition.

18. The apparatus of claim 17, wherein means for detecting a low performance condition further includes means for comparing a detected signal-to-noise ratio (“SNR”) against a predefined SNR.

19. The apparatus of claim 17, wherein means for detecting a low performance condition further includes means for detecting exceeding numbers of re-ranging of an optical network terminal (“ONT”).

20. The apparatus of claim 16, further comprising:
means for receiving the second data stream;
means for correcting an error in the second data stream in response to the ECC; and
means for removing the ECC from the second data stream to restore the first data stream with the first data format.
